(19) United States
(12) Patent Application Publication
(10) Pub. No.: US 2021/0206945 A1
(43) Pub. Date: Jul. 8, 2021

(54) CURABLE FLUORINE-BASED ELASTOMER COMPOSITE AND CURED PRODUCT THEREOF

(71) Applicant: 3M INNOVATIVE PROPERTIES COMPANY, St. Paul, MN (US)

(72) Inventors: Hirofumi Sonoda, Tokyo (JP); Yuta Suzuki, Kanagawa (JP)

(21) Appl. No.: 17/059,794

(22) PCT Filed: May 30, 2019
(86) PCT No.: PCT/IB2019/054499

§ 371 Date: Nov. 30, 2020

(30) Foreign Application Priority Data
May 31, 2018 (JP) 2018-105449

(51) Int. Cl. C08K 5/43; C08K 5/19; C08K 3/04; C08K 3/22

(52) U.S. Cl. CPC C08K 5/43; C08K 5/19; C08K 3/04; C08K 3/22; C08K 2003/2206; C08K 2201/005; C08K 2201/011; C08K 2003/222; C08K 2003/2296; C08K 2201/006

(57) ABSTRACT

A curable fluorine-based, elastomer comprising a curable fluorine-based elastomer, a carbon black, and anionic liquid; wherein the carbon black is contained in an amount not greater than 3 carts by. mass per 100 parts by mass of tile curable fluorine-based elastomer; and the ionic liquid is contained ¼ an amount not greater than 10 parts by mass per 100 parts by mass of the curable fluorine-elastomer.

### FIELD

The present disclosure relates to a curable fluorine-based elastomer composite and a cured product thereof.

### BACKGROUND

Fluorine-based materials are widely used as sealing materials for automobiles, aircraft, and the like due to their excellent chemical resistance, heat resistance, and electrical insulating properties. In more recent years, there have also been attempts to impart conductivity to a fluorine-based material by compounding a conductive agent such as conductive carbon with the fluorine-based material.

Patent Document 1 (JP 2013-237783 A) describes a conductive fluorine rubber composition containing a fluorine rubber and expanded graphite, wherein the amount of expanded graphite is from 35 parts by weight to 70 parts by weight per 100 parts by weight of the total amount of the fluorine rubber and expanded graphite.

Patent Document 2 (JP 2010-032812 A) describes a semiconductive fluororesin film formed from a fluororesin composition containing a fluororesin and a conductive agent, wherein the conductive agent is at least one type of conductive agent selected from the group consisting of an ionic liquid and a conductive polymer; and the average value of the surface resistivity of the semiconductive fluororesin film measured at a temperature of 20° C. and an applied voltage of 100 V is within a range of from 1×10⁵Ω/γ to 1×10¹⁶Ω/γ.

### SUMMARY

When imparting low electrostatic property (also referred to as conductivity or electrostatic resistance) to a fluorine-based elastomer (also referred to as a fluorine-based rubber) by compounding a conductive carbon with the fluorine-based rubber, the carbon was typically compounded with a high degree with the fluorine-based elastomer. As a result, although the obtained fluorine-based elastomer yielded a low electrostatic property, the flexibility and molding processability may be diminished. In addition, when conductive carbon is simply compounded with a fluorine-based elastomer, the dispersibility (uniformity of low electrostatic property) may also be diminished.

The present disclosure provides a curable fluorine-based elastomer composite capable of yielding a cured product having excellent flexibility and a low electrostatic property.

According to an embodiment of the present disclosure, provided is a curable fluorine-based elastomer composite containing a curable fluorine-based elastomer, a carbon black, and an ionic liquid; wherein the carbon black in an amount not greater than approximately 3.0 parts by mass per 100 parts by mass of the curable fluorine-based elastomer; and the ionic liquid is contained in an amount not greater than approximately 10 parts by mass per 100 parts by mass of the curable fluorine-elastomer.

According to another embodiment of the present disclosure, provided is a cured product of fluorine-based elastomer composite, wherein the cured product has a durometer A hardness of less than approximately 65 and has a volume resistivity not greater than approximately 1×10⁹ Ω·cm.

In some embodiments, a curable fluorine-based elastomer composite capable of yielding a cured product having excellent flexibility and low electrostatic property can be provided.

In some embodiments, a cured product having excellent flexibility and low electrostatic property—in particular, excellent heat resistance, chemical resistance, and the like in addition to uniform low electrostatic property—can be provided.

### DETAILED DESCRIPTION

The curable fluorine-based elastomer composite according to a first embodiment of the present disclosure contains a curable fluorine-based elastomer, a carbon black, and an ionic liquid; wherein the carbon black is contained in an amount not greater than approximately 3 parts by mass per 100 parts by mass of the curable fluorine-based elastomer; and the ionic liquid is contained in an amount not greater than approximately 10 parts by mass per 100 parts by mass of the curable fluorine-elastomer. The composite contains the carbon black and the ionic liquid in specific proportions, and thus the cured product obtained from the composite can enhance the performance in terms of both flexibility and low electrostatic property, which are conflicting types of performance.

At least one type selected from a binary fluorine-based elastomer and a ternary fluorine-based elastomer can be used as the curable fluorine-based elastomer of the composite according to the first embodiment. This elastomer can enhance the performance such as the flexibility, heat resistance, and chemical resistance of the obtained cured product.

Regarding elastomers that may be used as the curable fluorine-based elastomer of the composite in the first embodiment, a vinylidene fluoride/hexafluoropropylene copolymer may be used as a binary fluorine-based elastomer, and a vinylidene fluoride/hexafluoropropylene/tetrafluorethylene copolymer may be used as a ternary fluorine-based elastomer. This elastomer can further enhance the performance such as the flexibility, heat resistance, and chemical resistance of the obtained cured product.

A carbon black having a DBP oil absorption of not less than approximately 110 cm³/100 g can be used as the carbon black of the composite in the first embodiment, and a carbon black having a BET specific surface area of not less than approximately 200 m²/g can be used. This carbon black can further enhance the low electrostatic property while maintaining sufficient flexibility of the obtained cured product.

A carbon black having a pH of not less than approximately 7.0 can be used as the carbon black of the composite in the first embodiment, and a carbon black having an average particle size not greater than approximately 40 nm can be used. This carbon black is unlikely to have a negative impact on the curability of the composite and can further enhance the low electrostatic property.

The cured product in a second embodiment of the present disclosure is obtained by curing the composite of the first embodiment, and the cured product may have a durometer A hardness of less than approximately 65 and a volume resistivity not greater than approximately 1×10⁹ ohm-centimeter (Ω·cm). The cured product contains specific amounts of carbon black and an ionic liquid, and thus the performance with regard to both hardness and volume resistivity can be satisfied.

In some embodiments, the cured product of the second embodiment has sufficient chemical resistance, and thus the cured product can be used in an acidic atmosphere or an environment in contact with an acidic solution.

In some embodiments, the cured product of the second embodiment has sufficient flexibility and low electrostatic property, and thus the cured product can be used for a vacuum pad.

In the present disclosure, “composite” can mean a blend, formulation, or mixture of two or more components.

In the present disclosure. “curing” may also a concept commonly referred to as “crosslinking”. Note that the curable fluorine-based elastomer of the present disclosure has rubber elasticity as an elastomer after curing.

In the present disclosure, “heat resistance” can refer to the performance enabling continuous use over a long period of time at a high temperature. A high-temperature environment may be defined, for example, as not lower than approximately 180° C., not lower than approximately 190° C., or not lower than approximately 200° C. and not higher than approximately 250° C., not higher than approximately 240° C., or not higher than approximately 230° C. The period of time may be defined, for example, as not less than approximately 1 week, not less than approximately 30 days, or not less than approximately 1 year and not greater than approximately 5 years, not greater than approximately 3 years, or not greater than approximately 2 years.

In the present disclosure, “chemical resistance” can encompass various types of chemical resistance such as oil resistance, alcohol resistance, acid resistance, and alkaline resistance, Examples of specific chemicals include hydrocarbons such as n-hexane, isooctane, benzene, toluene, and ethylene gas; oils such as fuels used in various vehicles, ships, aircraft, and the like or lubricating oils used in various manufacturing devices and the like; aldehydes such as formaldehyde; alcohols such as methanol, ethanol, and ethylene glycol; sulfur-containing compounds such as carbon disulfide; phosphorus-containing compounds such as tricresyl phosphate; acids such as hydrochloric acid and sulfuric acid; alkalis such as ammonia water and sodium hydroxide; and other substances such as phenol, chlorine, bromine, and hydrogen peroxide.

### Curable Fluorine-Based Elastomer Composite

The curable fluorine-based elastomer composite of an embodiment of the present invention (which may also be simply referred to as “composite” hereinafter) contains a curable fluorine-based elastomer (which may also be simply referred to as “fluorine-based elastomer” or “elastomer” hereinafter), a carbon black, and an ionic liquid. With such a carbon black alone, the desired low electrostatic property can be achieved for the obtained article, but the article becomes hard, which makes it difficult to achieve the desired flexibility, and with an ionic liquid alone, it is difficult to achieve the desired low electrostatic property.

The carbon black is contained in the composite at a proportion not greater than approximately 3.0 parts by mass per 100 parts by mass of the curable fluorine-based elastomer. From the perspective of the expression of flexibility, low electrostatic property, mechanical strength, and the like, the carbon black may be contained in the composite at a proportion of less than approximately 3.0 parts by mass, not greater than approximately 2.9 parts by mass, not greater than approximately 2.8 parts by mass, or not greater than approximately 2.7 parts by mass and at a proportion of not less than approximately 1.0 parts by mass, not less than approximately 1.2 parts by mass, or not less than approximately 1.5 parts by mass per 100 parts by mass of the curable fluorine-based elastomer.

The ionic liquid is contained in the composite at a proportion not greater than approximately 10 parts by mass per 100 parts by mass of the curable fluorine-based elastomer. From the perspective of flexibility, low electrostatic property, and the like, the ionic liquid may be contained in the composite at a proportion of less than approximately 10 parts by mass, not greater than approximately 9 parts by mass, not greater than approximately 8 parts by mass, or not greater than approximately 7 parts by mass and at a proportion of not less than approximately 2.0 parts by mass, not less than approximately 0.5 parts by mass, or not less than approximately 1 parts by mass per 100 parts by mass of the curable fluorine-based elastomer.

### Curable Fluorine-Based Elastomer

The curable fluorine-based elastomer of the present disclosure may be any elastomer that exhibits flexibility, chemical resistance, and the like. Although not limited to the following, a fluorine-based elastomer (rubber) obtained by polymerizing one or more types of fluorinated monomers or partially fluorinated monomers, for example, can be used. The fluorine-based elastomer of the present disclosure is curable, and therefore the elastomer can be cured (crosslinked) and used. For example, a composite containing the elastomer may be distributed in an uncured state or may be cured when processed as a member.

Specific examples of such fluorine-based elastomers include one or more types of fluorine-based elastomers primarily composed of one or more types of fluorine-based monomers such as tetrafluoroethylene, vinyl fluoride, vinylidene fluoride, hexafluoropropylene, pentafluoropropylene, trifluoroethylene, trifluorochloroethylene, perfluoromethyl vinyl ether, and perfluoropropyl vinyl ether. Among these, from the perspective of flexibility, heat resistance, strength, and the like, at least one type selected from binary fluorine-based elastomers and ternary fluorine-based elastomers is preferably used, and in particular, vinylidene fluoride/hexafluoropropylene copolymers and vinylidene fluoride/hexafluoropropylene/tetrafluoroethylene copolymers are more preferable. Here, “binary” and “ternary” are intended to refer to the number of monomer units of the fluorine-based monomer constituting the copolymer. That is, a binary system is intended to include monomer units composed of two types of fluorine-based monomers, and a ternary system is intended to include monomer units composed of three types of fluorine-based monomers. For example, in a case where a copolymer contains two types of fluorine-based monomer units and any of the monomer units listed below other than fluorine-based units, the copolymer is a binary fluorine-based elastomer.

The Dyneon (trade name) series available from 3M, for example, may be used as such a binary fluorine-based elastomer and a ternary fluorine-based elastomer. Specifically, FC2110Q, FC2120, FC2121, FC2122, FC2123, FC2144, FC2145, FC2152, FC2170, FC2174, FC2176, FC2177D, FC2178, FC2179, FC2180, FC2181, FC2182, FC2211, FC2230, FC2260, FC2261Q, FE5520X, FE5542X, FE5610, FE5610Q, FE5620Q, FE5621, FE5622Q, FE5623, FE5640Q, FE5641Q, F5642, FE5643Q, FE5660Q, FC5630Q, FG5661X, FG5690Q, FX3734, FX3735, FX11818, and the like may be used as a binary fluorine-based elastomer.

FE5522X, FE5730, FE5830Q, FE5840Q, FLS2530 FLS2650, FPO3630, FPO3740, FPO3741, FT2320, FT2350, FT2430, FT241, and the like may be used as a ternary fluorine-based elastomer.

### Optional Monomers

The curable fluorine-based elastomer of the present disclosure may be copolymerized with other monomers other than fluorine-based monomers within a range that does not affect the effects of the present invention. For example, the elastomer can be modified by copolymerizing monomers such as ethylene, propylene, and butylene. These optional monomers can be used in a range not greater than approximately 25 mol %, not greater than approximately 10 mol %, or not greater than approximately 3 mol % of the fluorine-based elastomer composition, but the monomer units based on the optional monomers are preferably within a range that does not inhibit properties such as rubber elasticity as a fluorine-based elastomer.

### Curing Agent

The curable fluorine-based elastomer of the present disclosure is not limited to the following, but may be cured (crosslinked) using a curing agent (also called a crosslinking agent) such as a peroxide, polyol, or polyamine.

Curing using a peroxide is typically performed using an organic peroxide as a curing agent and, as necessary, a diallyl ether of glycerin, triallyl phosphate, diallyl adipate, diallyl melamine, triallyl isocyanurate (TAIC), tri(methyl)allyl isocyanurate (TMAIC), tri(methyl)allyl cyanurate, poly-triallyl isocyanurate (poly-TAIC), xylylene-bis(diallyl isocyanurate (XBD), N,N′-m-phenylene bismaleimide, or the like.

Examples of organic peroxides include benzoyl peroxide, dicumyl peroxide, di-t-butyl peroxide, 2,5-di-methyl-2,5-di-t-butylperoxy hexane, 2,4-dichlorobenzoyl peroxide, 1,1-bis(t-butylperoxy)-3,3,5-trimethylchlorohexane, t-butyl isopropyl percarbonate (TBIC), t-butyl-2-ethylhexyl percarbonate (TBEC), t-amyl-2-ethylhexyl percarbonate, t-hexyl isopropyl percarbonate, carbonoperoxoic acid=O,O′-1,3-propanediyl=OO,OO′-bis(1,1-dimethylethyl)ester, 2-ethyl hexane peroxoic acid-t-hexyl, 2-ethyl hexane peroxoic acid t-butyl, di(4-methylbenzoyl) peroxide, and cyclohexanone peroxide.

Curing using a polyol can typically be performed using a polyol compound as a curing agent, a curing aid such as an onium salt—for example, an ammonium salt, a phosphonium salt, an iminium salt, or the like—and an acid acceptor such as a hydride or oxide of a divalent metal such as magnesium, calcium, or zinc.

Examples of polyol compounds include bisphenol AF, bisphenol A, bisphenol S dihydroxybenzophenone, hydroquinone, 2,4,6-trimercapto-S-triazine, 4,4′-thiodiphenol, and metal salts thereof.

Curing using a polyamine can typically be performed using a polyamine compound or a precursor thereof as a curing agent and an acid acceptor such as an oxide of a divalent metal such as magnesium, calcium, or zinc.

Examples of polyamine compounds or precursors of polyamine compounds include hexamethylene diamine and carbamates thereof, 4,4′-bis(aminocyclohexyl)methane and carbamates thereof, and N,N′-dicinnamylidene-1,6-hexamethylene diamine.

The amounts of these curing agents, curing aids, and acid receptors are not particularly limited and can be determined appropriately while taking into consideration flexibility, mechanical strength, productivity, and the like.

### Carbon Black

One requirement of the carbon black of the present disclosure (also referred to as conductive carbon black) is that it can impart low electrostatic property to the resulting article. In addition, another requirement is that the carbon black is unlikely to decompose the fluorine-based elastomer by generating heat and reacting with the fluorine-based elastomer during the kneading operation of the fluorine-based elastomer (in this regard, a metal powder has high conductivity but does not satisfy this requirement, and therefore a metal powder is preferably not used). The carbon black of the present disclosure is not limited to the following, but acetylene black, furnace black, ketjen black, and the like can be used alone or in a combination of two or more types thereof, for example. Of these, ketjen black is preferable from the perspective of the expression of low electrostatic property and mechanical strength in the obtained article. Here, the carbon black does not include carbons called fullerene, graphene, carbon nanohorns, carbon nanofibers, or carbon nanotubes. These materials are more expensive than carbon black, and therefore result in an increase in product cost, and the work environment may be deteriorated due to being prone to scattering in the form of dust in the kneading operation or the like.

The DBP oil absorption of the carbon black may be defined, for example, as not less than approximately 110 cm³/100 g, not less than approximately 130 cm³/100 g, not less than approximately 150 cm³/100 g, or not less than approximately 200 cm³/100 g, and although there is no particular upper limit, the DBP oil absorption may be defined as not greater than approximately 1000 cm³/100 g. not greater than approximately 800 cm³/100 g. or not greater than approximately 600 cm³/100 g from the perspective of low electrostatic property or the like. Here, the DBP oil absorption of carbon black is the value of DBP (dibutyl phthalate) absorbed by 100 g of carbon black under conditions conforming to ASTM D 2414, and is generally known to contribute to low electrostatic property (conductivity).

From the perspective of low electrostatic property or the like, the BET specific surface area of the carbon black may be defined, for example, as not less than approximately 200 m²/g, not less than approximately 250 m²/g, not less than approximately 300 m²/g, or not less than approximately 500 m²/g, and although there is no particular upper limit, the BET specific surface area may be defined as not greater than approximately 10000 m²/g, not greater than approximately 5000 m²/g, or not greater than approximately 2000 m²/g. Here, the BET specific surface area of carbon black is a value measured by a method conforming to ASTM D 3037, and is generally known to contribute to low electrostatic property (conductivity).

The pH of an aqueous dispersion containing the carbon black may be defined as not lower than approximately 7.0, not lower than approximately 7.5, or not lower than approximately 8.0 and not higher than approximately 13.0, not higher than approximately 12.0, or not higher than approximately 11.0 from the perspective of the curability of the composite (not inhibiting crosslinking reactions). In the present disclosure, the expression “pH of carbon black” refers to the pH of an aqueous dispersion containing the carbon black. Here, the pH of the carbon black is a value measured by a method conforming to ASTM D 1512, for example, and can be determined by measuring the pH of a supernatant liquid after boiling treatment adjustment with a glass electrode type pH meter.

When a metal oxide such as zinc oxide or a metal oxide doped with a heteroelement is used together with carbon black, the metal oxide can act in an auxiliary manner with respect to low electrostatic property and/or mechanical strength so as to further enhance these types of performance. The compounding ratio (mass ratio) of the carbon black to the metal oxide may be from approximately 1:5 to approximately 51, preferably from approximately 1:4 to approximately 4:1, and more preferably from approximately 1:3 to approximately 3:1.

The average particle size (primary particle size) of the carbon black is not limited to the following, but from the perspective of the expression of low electrostatic property and mechanical strength, the average particle size may be defined, for example, as not less than approximately 1 nm, not less than approximately 5 nm, or not less than approximately 10 nm and not greater than approximately 40 nm, not greater than approximately 38 nm, or not greater than approximately 35 nm. The average particle size can be measured by a common method such as dynamic light scattering, transmission electron microscopy, or scanning electron microscopy.

Various types of surface treatment can be applied to the carbon black in order to enhance dispersibility in the composite. For example, fluoridation treatment may be performed on the surface of the carbon black by applying fluorine gas to the carbon black in a high-temperature environment of not lower than approximately 200° C. as necessary. However, from the perspective of low electrostatic property, the surface treatment is preferably not applied to the carbon black.

### Ionic Liquid

The ionic liquid of the present disclosure may be any ionic liquid that is compatible with the composite and can exhibit the desired low electrostatic property performance for the resulting article. An ionic liquid can typically refer to a substance that is composed of a cation (positive ion) and an anion (negative ion) and has a melting point not higher than approximately 100° C.—that is, the substance is a liquid at approximately 100° C. or lower. Due to the presence of a compound that is in a molten state even when the melting point is at or below room temperature, this is also sometimes referred to as a normal temperature molten salt or a room temperature molten salt. The cation and/or anion of the ionic liquid are sterically relatively bulky, and one or both are ordinarily organic ions. The ionic liquid can be synthesized by a known method such as, for example, anion exchange, an acid ester method, or neutralization.

The cation of the ionic liquid may be, but is not limited to, an ammonium ion, a phosphonium ion, a sulfonium ion, or the like, for example.

Examples of ammonium ions include ammonium ions selected from the group consisting of alkyl ammonium, imidazolium, pyridinium, pyrrolidinium, pyrrolinium, pyrazinium, pyrimidinium, triazonium, triazinium, quinolinium, isoquinolonium, indolinium, quinoxalinium, piperidinium, oxazolidinium, thiazolinium, morpholinium, piperadinium, and combinations thereof.

Examples of phosphonium ions include phosphonium ions selected from the group consisting of tetraalkyl phosphonium, aryl phosphonium, alkyl aryl phosphonium, and combinations thereof.

Examples of sulfonium ions include sulfonium ions selected from the group consisting of alkyl sulfonium, aryl sulfonium, thiophenium, tetrahydrothiophenium, and combinations thereof.

Alkyl groups directly bonded to the nitrogen atoms, phosphorus atoms, or sulfur atoms in these cations may be, for example, straight-chain, branched, or cyclic alkyl groups having from 1 to 20, from 1 to 12, or from 1 to 8 carbons. Aryl groups directly bonded to the nitrogen atoms, phosphorus atoms, or sulfur atoms of these cations may be, for example, monocyclic or condensed cyclic aryl groups having from 5 to 20 carbons. Any moieties in the structure constituting these cations may be further substituted with, for example, an alkyl group, an alkenyl group, an alkynyl group, a cycloalkyl group, an aryl group, an aralkyl group, an arylalkyl group, an alkoxy group, an aryloxy group, a hydroxyl group, a carbonyl group, a carboxyl group, an ester group, an acyl group, an amino group, an amide group, an imino group, an imide group, a nitro group, a nitrile group, a sulfide group, a sulfoxide group, a sulfone group, a halogen atom, or the like, and the main chain or ring of the structure constituting the cations may contain a hetero atom such as an oxygen atom, a nitrogen atom, a sulfur atom, or a silicon atom.

Specific examples of cations include N-ethyl-N′-methylimidazolium, N-methyl-N-propylpiperidinium, N,N,N-trimethyl-N-propylammonium, N-methyl-N,N,N-tripropylammonium, N,N,N-trimethyl-N-butylammonium, N,N,N-trimethyl-N-ethoxyethylammonium, N-methyl-N,N,N-tris(methoxyethyl)ammonium, N,N-dimethyl-N-butyl-N-methoxyethylammonium, N,N-dimethyl-N,N-dibutylammonium, N-methyl-N,N-dibutyl-N-methoxyethylammnium, N-methyl-N,N,N-tributylammonium, N,N,N-trimethyl-N-hexylammonium, N,N-diethyl-N-methyl-N-(2-methoxyethyl)ammonium, 1-propyl-tetrahydrothiophenium, 1-butyl-tetrahydrothiophenium, 1-pentyl-tetrahydrothiophenium, 1-hexyl-tetrahydrothiophenium, glycidyl trimethylammonium, N-ethylacryloyl-N,N,N-trimethylammonium, N-ethyl-N-methylmorpholinium, N,N,N-trioctylammonium, and N-methyl-N,N,N-trioctylammonium.

Cations that do not contain functional groups or moieties that exhibit reactivity (for example, unsaturated bonds having reactive activity) are advantageous from the perspective of heat resistance, and examples of such cations include N-methyl-N-propylpiperidinium and N,N,N-trimethyl-N-propylammonium. It is expected that the compatibility with the fluorine-based elastomer will be good, and therefore it is advantageous for the group constituting the cation to be substituted with fluorine.

The anion of the ionic liquid may be, for example, a sulfate (R—OSO₃⁻), a sulfonate (R—SO₃⁻), a carboxylate (R—CO₂⁻), a phosphate ((RO)₂P(═O)O⁻), a borate represented by the formula BR⁴⁻ such as tetrafluoroborate (BF₄⁻) or tetraalkylborate, a phosphate represented by the formula PR₆⁻ such as hexafluorophosphate (PF₆⁻) or hexaalkylphosphate, an imide (R₂N⁻), a methide (R₃C⁻), a nitric acid ion (NO₃⁻), a nitrous acid ion (NO₂⁻), or the like. In the formulas, R may independently be a hydrogen atom, a halogen atom such as fluorine, chlorine, bromine, or iodine, or a substituted or unsubstituted alkyl group, alkenyl group, alkynyl group, cycloalkyl group, aryl group, aralkyl group, arylalkyl group, acyl group, or sulfonyl group. The main chain or ring of the group R may contain a hetero atom such as an oxygen atom, a nitrogen atom, or a sulfur atom, and some or all of the hydrogen atoms on the carbons of the group R may be substituted with fluorine atoms. When there are a plurality of R moieties in the anion, these R moieties may be the same as or different from each other. The compatibility with the fluorine-based elastomer is generally favorable, it is advantageous the some or all of the hydrogen atoms on the carbons of the group R of the anion to be substituted with fluorine atoms, and it is particularly advantageous for the anion to contain a perfluoroalkyl group.

As an anion containing a perfluoroalkyl group, bis(perfluoroalkylsulfonyl)imide ((R_{f}SO₂)₂N⁻), perfluoroalkylsulfonate (R_{f}SO₃⁻), tris(perfluoroalkylsulfonyl)methide ((R_{f}SO₂)₃C⁻), or the like can be advantageously used (in the formula, R_{f} represents a perfluoroalkyl group). The number of carbons of the perfluoroalkyl group may be, for example, from 1 to 20, from 1 to 12, or from 1 to 8.

Specific examples of bis(perfluoroalkylsulfonyl)imides include bis(trifluoromethanesulfonyl)imide, bis(pentafluoroethanesulfonyl)imide, bis(heptafluoropropanesulfonyl)imide, and bis(nonafluorobutanesulfonyl)imide.

Specific examples of perfluoroalkylsulfonates include trifluoromethanesulfonate, pentafluoroethanesulfonate, heptafluoropropanesulfonate, and nonatluorobutanesulfonate.

Specific examples of tris(perfluoroalkylsulfonyl)methides include tris(trifluoromethanesulfonyl)methide, tris(pentafluoroethanesulfonyl)methide, tris(heptafluoropropanesulfonyl)methide, and tris(nonafluorobutanesulfonyl)methide.

As the ionic liquid composed of a cation and an anion described above, N-methyl-N-propylpiperidiniumbis(trifluoromethanesulfonyl)imide, N-ethyl-N′-methylimidazoliumbis(trifluoromethanesulfonyl)imide, N,N,N-trimethyl-N-hexylamminiumbis(trifluoromethanesulfonyl)imide, and N-methyl-N,N,N-tributylamminiumbis(trifluoromethanesulfonyl)imide may be particularly advantageously used in that they have excellent heat resistance and good compatibility with the fluorine-based elastomer. For applications requiring low coloration, N-methyl-N-propylpiperidiniumbis(trifluoromethanesulfonyl)imide, N,N,N-trimethyl-N-hexylamminiumbis(trifluoromethanesulfonyl)imide, and N-methyl-N,N,N-tributylamminiumbis(trifluoromethanesulfonyl)imide are particularly suitable.

### Optional Components

The fluorine-based elastomer composite of the present disclosure may contain, as optional components, release agents, fillers, antioxidants, UV absorbers, light stabilizers, thermal stabilizers, dispersants, plasticizers, lubricants, surfactants, leveling agents, fluorine-based silane coupling agents, catalysts, pigments, dyes, and the like within a range that does not affect the effects of the present invention.

### Cured Product of the Curable Fluorine-Based Elastomer Composite

The curable fluorine-based elastomer composite of the present disclosure contains specific amounts of carbon black and an ionic liquid, and thus the obtained cured product can impart sufficient low electrostatic property and mechanical strength without substantially reducing the performance such as the heat resistance, chemical resistance, or flexibility of the elastomer itself. In particular, with regard to low electrostatic property, the cured product of the present disclosure can impart uniform low electrostatic property in each location of the cured product.

It is typically difficult to uniformly disperse carbon black in a fluorine-based elastomer, and there is a risk of causing unevenness in ow electrostatic property. In addition to the carbon black, the cured product of the present disclosure contains a prescribed amount of an ionic liquid that is easily miscible with the fluorine-based elastomer. As a result, the ionic liquid is interposed between the carbon blacks, and thus it is possible to compensate for unevenness in low electrostatic property.

### Performance of Cured Product

### Flexibility: Durometer a Hardness

The cured product of the present disclosure has sufficient flexibility. The flexibility can be evaluated by the durometer A hardness in accordance with JIS K6253, for example. This durometer A hardness may be defined as less than approximately 65, not greater than approximately 64, or not greater than approximately 63 or not less than approximately 50, not less than approximately 51, or not less than approximately 52.

### Low Electrostatic Property: Volume Resistivity

The cured product of the present disclosure has sufficient low electrostatic property. The low electrostatic property can be evaluated, for example, by volume resistivity in accordance with JIS K6911. The volume resistivity can be defined as not greater than approximately 1×10⁹ Ω·cm, not greater than approximately 8×10⁸ Ω·cm, or not greater than approximately 6×10⁸ Ω·cm and not less than approximately 1×10⁷ Ω·cm, not less than approximately 3×10⁷ Ω·cm, or not less than approximately 5×10⁷ Ω·cm.

### Uniformity of Low Electrostatic Property

The uniformity of low electrostatic property can be evaluated by the standard deviation of any at least six volume resistivity measurements in the measurement sample. The standard deviation may be defined as not greater than approximately 0.20, not greater than approximately 0.10, or not greater than approximately 0.05 and not less than approximately 0.00 or not less than approximately 0.01.

### Mechanical Strength: Tensile Strength

The cured product of the present disclosure can exhibit sufficient mechanical strength. The mechanical strength can be evaluated, for example, by the tensile strength in accordance with JIS K6251. The tensile strength can be defined as not less than approximately 2.0 MPa, not less than approximately 3.0 MPa, or not less than approximately 4.0 MPa and not greater than approximately 20.0 MPa, not greater than approximately 18.0 MPa, or not greater than approximately 16.0 MPa.

### Mechanical Strength: Elongation Ratio

The mechanical strength of the cured product of the present disclosure can also be evaluated, for example, by the elongation ratio in accordance with JIS K6251. The elongation ratio may be defined as not less than approximately 150%, not less than approximately 170%, or not less than approximately 190% and not greater than approximately 500%, not greater than approximately 470%, or not greater than approximately 450%.

### Specific Gravity

The specific gravity of the cured product of the present disclosure may be defined, for example, as not less than approximately 1.70, not less than approximately 1.72, or not less than approximately 1.75 and not greater than approximately 1.95, not greater than approximately 1.93, or not greater than approximately 1.90.

### Applications

The cured product obtained from the curable fluorine-based elastomer composite of the present disclosure has at least excellent flexibility and low electrostatic property and can also exhibit the heat resistance and chemical resistance of the fluorine-based elastomer itself, and therefore the cured product can be used in various applications. Although not limited to the following, the cured product can be used in applications in which the cured product is used at a high temperature of not lower than approximately 180° C. or not higher than approximately 200° C. and/or in an environment in which the cured product is in contact with chemicals—in particular, an environment in which the cured product contacts with an acidic atmosphere or an acidic solution.

Specifically, examples of members used in vehicles, ships, aircraft, various manufacturing devices, chemical or fuel transport, and the like include vacuum pads used to absorb and transport articles such as display panels or semiconductor wafers; various sealing members such as o-rings, packings, and gaskets; and other members such as joints, adapters, pipes, hoses, belts, tubes, and rollers. In this manner, the form of the cured product may be any form, and the cured product may also be used appropriately in the form of coatings, films, plates, containers, various jigs, valves, stirring blades, cooking equipment, or the like. These molded products can be formed appropriately using known methods such as coating methods, injection molding methods, compression molding, and extrusion methods.

When used in such applications, the cured product may be used alone, in combination with other parts, or in a laminated configuration. In the case of a laminate configuration, for example, a configuration in which a cured product layer is applied to one or both surfaces of a reinforcing layer or support layer such as a polyamide fabric, a configuration in which an adhesive layer such as a pressure-sensitive adhesive is applied to the cured product layer, or the like may be use employed.

Method for Producing Curable Fluorine-Based Elastomer Composite and Cured Product Thereof

The method for producing the curable fluorine-based elastomer composite of the present disclosure is not particularly limited, but the curable fluorine-based elastomer composite may be prepared, for example, by compounding a curable fluorine-based elastomer, a carbon black, an ionic liquid, and the optional components described above as necessary in any order and mixing the components thoroughly. The mixing of these components can be performed using, for example, a two-roll mill (open roll mill), a kneader, a Banbury, a twin-screw kneader/extruder, various other mixers or kneaders, or the like.

When curing the composite, curing may be performed inside or outside a mixer during or after mixing the respective components, inside or outside a molding device at the time of the formation of a molded product, or after the molded product is shipped. This curing may be performed using heat or the like during mixing or molding, or the product may be cured continuously or intermittently using a separate heating step.

### EXAMPLES

The materials shown in Table 1 were mixed using an open roll mill at the compounding ratios shown in Table 2 to prepare each curable fluorine-based elastomer composite. Here, all of the numerical values in Table 2 refer to parts by mass.

TABLE 1
List of materials.

| COMPOUND and Provider | DESCRIPTION |
|---|---|
| DYNEON (TRADE NAME) | CURABLE FLUORINE-BASED ELASTOMER |
| FC-2144 | COMPOSITION CONTAINING POLYOL CURING-TYPE |
| 3M COMPANY (US) | VINYLIDENE FLUORIDE/HEXAFLUOROPROPYLENE |
| | COPOLYMER AND CURING AGENT |
| DYNAMAR (TRADE NAME) | CURING ACCELERATOR FOR CURABLE FLUORINE- |
| FC-2172 | BASED ELASTOMER COMPOSITION CONTAINING |
| 3M COMPANY (US) | POLYOL CURING-TYPE VINYLIDENE |
| | FLUORIDE/HEXAFLUOROPROPYLENE COPOLYMER |
| | AND CONTAINING HIGH DEGREE OF CURING AGENT |
| DYNEON (TRADE NAME) | CURABLE FLUORINE-BASED ELASTOMER |
| FPO-3630 | COMPOSITION CONTAINING PEROXIDE CURING-TYPE |
| 3M COMPANY (US) | VINYLIDENE FLUORIDE/HEXAFLUOROPROPYLENE/ |
| | TETRAFLUOROETHYLENE COPOLYMER AND CURING |
| | AGENT |
| FC-4400 | IONIC LIQUID-TYPE ANTISTATIC AGENT Tri-n- |
| 3M COMPANY (US) | butylmethylammonium bis-trifluoromethanesulfonimide. |
| FC-5000 | IONIC LIQUID-TYPE ANTISTATIC AGENT |
| 3M COMPANY (US) | QUATERNARY ALKYLAMMONIUM SULFONIMIDE |
| EC600JD | CARBON BLACK (KETJEN BLACK) AVERAGE |
| LION SPECIALTY | PARTICLE SIZE: 34 nm; DBP OIL ABSORPTION: 495 |
| CHEMICALS CO., LTD. | cm3/100 g; BET SPECIFIC SURFACE AREA: 1270 m2/g; |
| (SUMIDA-KU, TOKYO, JP) | pH: 9.0 g |
| VULCAN (TRADE NAME) | CARBON BLACK (FURNACE BLACK) AVERAGE |
| XC72 | PARTICLE SIZE: 30 nm: DBP OIL ABSORPTION: 174 |
| CABOT CORPORATION (US) | cm3/100 g; BET SPECIFIC SURFACE AREA: 254 m2/g |
| CONDUCTIVITY: ZnO 23-K | CONDUCTIVE ZINC OXIDE WITH AVERAGE PARTICLE |
| HAKUSUI TECH (KITA-KU, | SIZE OF FROM 120 TO 250 nm |
| OSAKA, JAPAN) | |
| MgO #150 | ACID ACCEPTOR MAGNESIUM OXIDE |
| KYOWA CHEMICAL | |
| INDUSTRY CO., LTD. | |
| (SAKAIDE-SHI, KAGAWA, | |
| JAPAN) | |
| Ca(OH)₂ | ACID ACCEPTOR CALCIUM HYDROXIDE |
| OHMI CHEMICAL INDUSTRY | |
| CO., LTD. (MAIBARA-SHI, | |
| SHIGA, JAPAN) | |
| PERHEXA (TRADE NAME) | CURING AGENT 2,5-Dimethyl-2,5(t-butylperoxy)hexane |
| 25B | |
| NOF CORPORATION | |
| (SHIBUYA-KU, TOKYO, | |
| JAPAN) | |
| TAIC (TRADE NAME) | CURING AID TRIALLYL ISOCYANURATE |
| MITSUBISHI CHEMICAL | |
| CORPORATION (CHIYODA- | |
| KU, TOKYO, JAPAN) | |
| CARNAUBA WAX | MOLD RELEASE AGENT |
| S. KATO & CO. (OSAKA-SHI, | |
| OSAKA, JAPAN) | |

TABLE 2
Examples EX 1-EX 8 and Comparative Examples CE 1-CE 5.

| | EX 1 | EX 2 | EX 3 | EX 4 | EX 5 | EX 6 | EX 7 | EX 8 |
|---|---|---|---|---|---|---|---|---|
| FC-2144 | 100 | 100 | 100 | 100 | 100 | 100 | 100 | — |
| FC-2172 | 1 | 1 | 1 | 1 | 1 | 1 | 1 | — |
| FPO-3630 | — | — | — | — | — | — | — | 100 |
| EC600JD | 2.5 | 2.5 | 2.5 | 2.5 | 2.5 | — | — | 2.5 |
| VULCAN XC72 | — | — | — | — | — | — | 2.5 | — |
| ZnO 23-K | — | 5 | — | — | — | — | — | — |
| FC-4400 | 1 | 1 | 3 | 5 | 10 | — | 3 | 3 |
| FC-5000 | — | — | — | — | — | 3 | — | — |
| MgO #150 | 3 | 3 | 3 | 3 | 3 | 3 | 3 | — |
| Ca(OH)₂ | 4 | 4 | 4 | 4 | 4 | 4 | 4 | — |
| PERHEXA 25B | — | — | — | — | — | — | — | 3 |
| TAIC | — | — | — | — | — | — | — | 3 |
| CARNAUBA WAX | 1 | 1 | 1 | 1 | 1 | 1 | 1 | 1 |

| | CE 1 | CE 2 | CE 3 | CE 4 | CE 5 |
|---|---|---|---|---|---|
| FC-2144 | 100 | 100 | 100 | 100 | 100 |
| FC-2172 | 1 | 1 | 1 | 1 | 1 |
| FPO-3630 | — | — | — | — | — |
| EC600JD | 2.0 | 2.5 | 3.0 | 2.5 | — |
| VULCAN XC72 | — | — | — | — | — |
| ZnO 23-K | — | — | — | 5 | 20 |
| FC-4400 | — | — | — | — | — |
| FC-5000 | — | — | — | — | — |
| MgO #150 | 3 | 3 | 3 | 3 | 3 |
| Ca(OH)₂ | 4 | 4 | 4 | 4 | 4 |
| PERHEXA 25B | — | — | — | — | — |
| TAIC | — | — | — | — | — |
| CARNAUBA WAX | 1 | 1 | 1 | 1 | 1 |

### Evaluation Tests

The curing properties of the curable fluorine-based elastomer composite and various physical properties of the cured product of the composite were evaluated using the following methods. The results are summarized in Table 3.

### Curing Properties

Uncured composites were tested in accordance with JIS K6300-2 2001 for 10 minutes at 170° C. using an RPA 2000 instrument in a moving die rheometer (MDR, sealed twisted shearing rotor-less hardness meter) mode available from Alpha Technologies (California, US). Both the minimum torque (ML) obtained during a prescribed amount of time and the highest torque (MH) in a case where no flat part or maximum torque was obtained were measured. Further, the time (Ts2) at which the torque rises 0.2 N·m from ML, the times to reach values equal to each of ML+0.1 (MH-ML), ML+0.5 (MH-ML), and ML+0.9 (MH-ML), and the “TC10” (10% curing time) “TC50” (50% curing time), and “TC90” (90% curing time) were measured sequentially.

### Hardness: Durometer A Hardness

The durometer A hardness was measured using a type-A durometer in accordance with JIS K6253. Here, the test piece was formed by preparing each composite at the prescribed dimensions described in JIS K6253, curing the composite for 10 minutes in a state in which a pressure of 20 MPa was applied for 10 minutes at 170° C., and then leaving the composite to stand for 24 hours in an oven at 230° C.

### Tensile Strength and Elongation Ratio

The tensile strength and elongation ratio were measured in accordance with JIS K 6251 for a test piece cut from a cured product sheet of each composite into a dumbbell-shaped No. 3 shape described in JIS K 6251 using a die. Here, the cured product sheet was formed by preparing each composite into a sheet shape, curing the composite in a state in which a pressure of 20 MPa was applied for 10 minutes at 170° C., and then leaving the composite to stand for 24 hours in an oven at 230° C.

### Low Electrostatic Property: Volume Resistivity

A test piece of a size of 8 cm×8 cm×2 mm was prepared from the cured product sheet of each composite, and after the volume resistivity of the test piece was measured six times in accordance with JIS K 6911 using R8340A available from Advantest, the average value and standard deviation thereof were calculated. Here, the cured product sheet was formed by preparing each composite into a sheet shape, curing the composite in a state in which a pressure of 20 MPa was applied for 10 minutes at 170° C., and then leaving the composite to stand for 24 hours in an oven at 230° C.

TABLE 3
Results for Examples EX 1 to EX 8 and Comparative Examples CE 1-CE 5.

| | | EX 1 | EX 2 | EX 3 | EX 4 | EX 5 | EX 6 | EX 7 | EX 8 |
|---|---|---|---|---|---|---|---|---|---|
| CURING | ML(dNm) | 2.0 | 2.1 | 1.9 | 1.7 | 1.4 | 1.8 | 1.4 | 1.0 |
| PROPERTIES | MH(dNm) | 9.7 | 10.1 | 10.1 | 9.7 | 8.8 | 4.9 | 10.0 | 9.7 |
| | Ts2 (min) | 2.6 | 2.5 | 2.2 | 2.1 | 2.4 | 7.1 | 1.6 | 0.9 |
| | TC10 (min) | 1.9 | 1.8 | 1.7 | 1.6 | 1.6 | 2.3 | 1.3 | 0.8 |
| | TC50 (min) | 3.4 | 3.3 | 2.9 | 2.8 | 3.3 | 5.9 | 1.9 | 1.2 |
| | TC90 (min) | 6.0 | 5.8 | 5.4 | 5.2 | 6.0 | 9.0 | 4.0 | 3.0 |
| PHYSICAL | DUROMETER A | 61 | 62 | 59 | 58 | 55 | 62 | 53 | 61 |
| PROPERTIES | HARDNESS | | | | | | | | |
| | TENSILE | 10.9 | 12.4 | 10.5 | 9.7 | 8.3 | 10.2 | 8.9 | 4.2 |
| | STRENGTH | | | | | | | | |
| | (MPa) | | | | | | | | |
| | ELONGATION | 410 | 430 | 390 | 350 | 350 | 430 | 330 | 200 |
| | RATIO (%) | | | | | | | | |
| | SPECIFIC | 1.83 | 1.89 | 1.82 | 1.80 | 1.77 | 1.82 | 1.82 | 1.81 |
| | GRAVITY | | | | | | | | |
| | VOLUME | 3.44 × | 3.39 × | 2.17 × | 1.66 × | 1.22 × | 1.96 × | 3.25 × | 1.04 × |
| | RESISTIVITY | 10⁸ | 10⁸ | 10⁸ | 10⁸ | 10⁸ | 10⁸ | 10⁸ | 10⁸ |
| | (Ω · cm) | | | | | | | | |
| | Standard | 0.01 | 0.02 | 0.02 | 0.00 | 0.01 | 0.01 | 0.02 | 0.00 |
| | Deviation of Vol. | | | | | | | | |
| | Resistivity | | | | | | | | |

| | | CE 1 | CE 2 | CE 3 | CE 4 | CE 5 |
|---|---|---|---|---|---|---|
| CURING | ML(dNm) | 1.9 | 2.1 | 2.4 | 2.3 | 1.8 |
| PROPERTIES | MH(dNm) | 9.4 | 8.9 | 8.9 | 9.5 | 11.5 |
| | Ts2 (min) | 2.1 | 2.7 | 2.8 | 2.4 | 1.4 |
| | TC10 (min) | 1.7 | 2.0 | 1.9 | 1.8 | 1.2 |
| | TC50 (min) | 2.6 | 3.3 | 3.5 | 3.0 | 1.7 |
| | TC90 (min) | 5.3 | 6.3 | 6.1 | 5.6 | 3.1 |
| PHYSICAL | DUROMETER A | 59 | 62 | 65 | 65 | 57 |
| PROPERTIES | HARDNESS | | | | | |
| | TENSILE | 11.0 | 11.1 | 11.7 | 12.3 | 9.1 |
| | STRENGTH | | | | | |
| | (MPa) | | | | | |
| | ELONGATION | 410 | 440 | 450 | 450 | 340 |
| | RATIO (%) | | | | | |
| | SPECIFIC | 1.84 | 1.84 | 1.84 | 1.89 | 2.06 |
| | GRAVITY | | | | | |
| | VOLUME | 6.15 × | 5.22 × | 1.92 × | 3.44 × | 1.14 × |
| | RESISTIVITY | 10¹² | 10¹¹ | 10⁸ | 10¹¹ | 10¹² |
| | (Ω · cm) | | | | | |
| | Standard | 0.57 | 1.01 | 0.02 | 0.25 | 0.00 |
| | Deviation of Vol. | | | | | |
| | Resistivity | | | | | |

### Results

As can be seen from the results in Table 3, it was confirmed that the cured products of Examples 1 to 8 obtained from composites containing specific proportions of carbon black and an ionic liquid exhibited excellent results for performance with regard to both flexibility (durometer A hardness) and low electrostatic property (volume resistivity), but in the case of the cured products of Comparative Examples 1 to 5 which did not contain specific proportions of these agents, the performance with regard to either flexibility or low electrostatic property was inferior to that of the cured products of Examples 1 to 8.

As can be seen from the results of Comparative Examples 1 to 3, although the low electrostatic property and the uniformity standard deviation) thereof are typically enhanced in a case where the amount of carbon black is increased, the flexibility tends to decrease. On the other hand, it was confirmed that, although the compounded amount of carbon black was low in the cured products of Examples 1 to 8, both the low electrostatic property and the uniformity thereof were excellent, and the cured products can exhibit flexibility associated with lower amounts of carbon black.

1-10. (canceled)

11. A curable fluorine-based elastomer composite comprising:
a curable fluorine-based elastomer; not less than 1 and not greater than 3 parts by mass of carbon black per 100 parts by mass of the curable fluorine-based elastomer; and not less than 0.5 and not greater than 10 parts by mass of an ionic liquid per 100 parts by mass of the curable fluorine-based elastomer.

12. The composite according to claim 11, wherein the composite comprises not less than 2 parts by mass of the carbon black per 100 parts by mass of the curable fluorine-based elastomer; and not less than 2 parts by mass of the ionic liquid per 100 parts by mass of the curable fluorine-elastomer.

13. The composite according to claim 11, further comprising a metal oxide, wherein the mass ratio of the carbon black to the metal oxide is from 1:5 to 5:1.

14. The composite according to claim 11, wherein the curable fluorine-based elastomer is selected from the group consisting of a binary fluorine-based elastomer and a ternary fluorine-based elastomer.

15. The composite according to claim 14, wherein the curable fluorine-based elastomer is a vinylidene fluoride/hexafluoropropylene copolymer.

16. The composite according to claim 14, wherein the curable fluorine-based elastomer is a vinylidene fluoride/hexafluoropropylene/tetrafluoroethylene copolymer.

17. The composite according to claim 11, wherein a DBP oil absorption of the carbon black is not less than 110 cm³/100 g as measured according to the method of ASTM D 2414.

18. The composite according to claim 11, wherein a BET specific surface area of the carbon black is not less than 200 m²/g as measured according to the method of ASTM D 3037.

18. The composite according to claim 11, wherein a pH of the carbon black is not less than 7.0 as measured according to the method of ASTM D 1512.

19. The composite according to claim 11, wherein an average particle size of the carbon black is not less than 1 nm and not greater than 40 nanometers.

20. A cured product of the curable fluorine-based elastomer composite of claim 1, wherein the cured product has a durometer A hardness of less than 65 as measured in accordance with JIS K6253.

21. The cure product of claim 20, wherein the cured product has a volume resistivity not greater than 1×10⁹ ohm·centimeter as measured in accordance with JIS K6911.

22. The cured product according to claim 21, wherein the cured product is a vacuum pad.
